(19) United States
(12) Patent Application Publication
(10) Pub. No.: US 2010/0224377 A1
(43) Pub. Date: Sep. 9, 2010

(54) FIRE-EXTINGUSHING SPRAY NOZZLE AND FIRE-EXTINGUISHING EQUIPMENT

(75) Inventors: Akimitsu Kikkawa, Ibaraki (JP); Yoshio Watanabe, Ibaraki (JP); Takahiro Ishihara, Ibaraki (JP); Takafumi Anezaki, Ibaraki (JP); Tatsuki Endo, Ibaraki (JP)

Correspondence Address: BACON & THOMAS, PLLC, 625 SLATERS LANE, FOURTH FLOOR, ALEXANDRIA, VA, 22314-1176, US

(73) Assignee: Yamato Protec Corporation, Osaka (JP)

(21) Appl. No.: 12/733,423

(22) PCT Filed: Jun. 16, 2008
(86) PCT No.: PCT/JP2008/060952

§ 371 Date: Mar. 1, 2010

(51) Int. Cl. A62C 37/08

(52) U.S. Cl. 169/37

(57) ABSTRACT

Low-pressure fire-extinguishing liquid is converted into mist. A fire-extinguishing spray nozzle (10) comprises a main body (30) and an obstacle (36). The main body (30) has a port (40) for radially injecting the fire-extinguishing liquid. The obstacle (36) has an opposing surface (60) and is opposite to the port (40). The opposing surface (60) is arranged within a radial-injection region (102) of the fire-extinguishing liquid radially injected from the port (40). One part of the fire-extinguishing liquid radially injected from the port (40) collides with the opposing surface (60) and is reflected therefrom. The other part of the fire-extinguishing liquid radially injected from the port (40) passes around the opposing surface (60). The one part of the fire-extinguishing liquid is reflected from the opposing surface (60) and the other part passes around the opposing surface (60). In consequence, the fire-extinguishing liquid (72) reflected from the opposing surface (60) collides with the fire-extinguishing liquid (70) passing around the supposing surface (60). The collision between the fire-extinguishing liquids produces mist (74).

### TECHNICAL FIELD

The present invention relates to a fire-extinguishing spray nozzle and a fire-extinguishing equipment and particularly concerns a fire-extinguishing spray nozzle and a fire-extinguishing equipment capable of converting fire-extinguishing liquid of a low pressure into mist.

### BACKGROUND ART

The Patent Literature 1 discloses a nozzle head. This nozzle head comprises a header main body to which at least two nozzle chips are attached. These nozzle chips radially inject fine water mist into the same direction and each has an injection port attached to the header main body so that it projects from a surface thereof by a length of at least 10 mm.

The nozzle head disclosed in the Patent Literature 1 can extend the injection distance of the mist, enlarge the region surrounded by the mist and reduce the number of the nozzle heads to be set.

The Patent Literature 2 discloses a fire-extinguishing nozzle. This fire-extinguishing nozzle comprises a fluid chamber, which is provided with a liquid inlet and a gas inlet as well as a fluid outlet, and is divided into a plurality of small chambers. Each of these small chambers includes a liquid inlet and a gas inlet as well as a fluid outlet independently and is provided with a fluid-control device. The fluid-control device injects the liquid introduced into the small chambers so as to spread it from the fluid outlets thereof.

The fire-extinguishing nozzle disclosed in the Patent Literature 2 can effect the initial fire-extinguishing action within a wide range and besides at the initial term of the occurrence of the fire accident, can greatly shorten the period of time up to the commencement of the spray-injection, effective for the initial fire-extinguishment.

The Patent Literature 3 discloses a liquid-spray nozzle. This liquid-spray nozzle includes a dome-like recess and a cut-in groove which crosses a leading end portion of the recess. This cut-in groove is provided offset upwardly of a tubular axis.

The liquid-spray nozzle disclosed in the Patent Literature 3 can increase the injection distance of the liquid even if it is attached horizontally.

The Patent Literature 4 discloses a sprinkler fire-extinguishing piping. This sprinkler fire-extinguishing piping comprises a main water-supply piping to which an auxiliary piping is connected. The auxiliary piping is formed in the shape of a loop by using a flexible synthetic resin tube. The loop-shaped auxiliary piping has water-dividing headers of synthetic resin interposed in series therewith. Each of these water-dividing headers of synthetic resin has branching connection-portions at a plurality of portions. The branching connection-portions are communicated with a flexible tube of synthetic resin.

The sprinkler fire-extinguishing piping disclosed in the Patent Literature 4 can be transported easily to an installing site.

### Patent Literature 1: Patent Application Laid-Open No. 2002-336370.

### Patent Literature 2: Patent Application Laid-Open No. 2002-17883.

Patent Literature 3: Patent Application Laid-Open No. H9-988.
Patent Literature 4 Patent Application Laid-Open No. H10-314332.

### DISCLOSURE OF THE INVENTION

### Problem the Invention Attempts to Solve

However, any one of the inventions disclosed in the Patent Literatures 1 to 3 has a problem that it is unavoidable to relatively increase the pressure of the liquid to be supplied for radially injecting the mist. For example, the invention disclosed in the Patent Literature 1 presumes the liquid has a pressure of about 8 MPa. So far as the invention disclosed in the Patent Literature 4 is concerned, it does not disclose nor suggest to radially inject the mist.

The present invention has been created so as to solve the above problems and has an object to provide a fire-extinguishing spray nozzle and a fire-extinguishing equipment for converting the low-pressure fire-extinguishing liquid into mist.

### Means for Solving the Problem

In order to accomplish the object, according to a certain aspect of the invention, a fire-extinguishing spray nozzle 10 comprises a main body 30 and an obstacle 36. The main body 30 includes ports 40 and 41 for radially injecting fire-extinguishing liquid. The obstacle 36 serves to collide with the fire-extinguishing liquid radially injected from the ports 40 and 41. The obstacle 36 has opposing surfaces 60, 61, which are disposed opposite to the ports 40, 41. The opposing surfaces 60, 61 are arranged within a region 102 in which the fire-extinguishing liquid is radially injected from the ports 40, 41.

Since the opposing surfaces 60, 61 are situated within the radial-injection region 102, one part of the fire-extinguishing liquid radially injected from the ports 40, 41 collides with the opposing surfaces 60, 61 and is reflected. The other part of the fire-extinguishing liquid radially injected from the ports 40, 41 passes around the obstacle 36. The one part of the fire-extinguishing liquid is reflected from the obstacle 36 and the other part passes around the obstacle 36. In consequence, the fire-extinguishing liquid 72 reflected from the opposing surfaces 60, 61 collides with the fire-extinguishing liquid 70 which passes around the opposing surface 60. The collision between the fire-extinguishing liquids produces the mist 74. When producing the mist 74 by such an action, the fire-extinguishing liquid to be radially injected from the ports 40, 41 may have a low pressure. As a result, this can provide a fire-extinguishing nozzle 10 for converting the low-pressure fire-extinguishing liquid into mist.

Further, the above-mentioned opposing surfaces 60, 61 are advantageously similar to the ports 40, 41 in shape.

Or advantageously the port 40 has a circular shape and the opposing surface 60 is also circular in shape.

Further, each of the opposing surfaces 60, 61 has a center axis desirably coincident with that of each of the ports 40, 41.

Besides, the obstacle 36 is advantageously fixed to the main body 30 via a support portion 32.

Alternatively, it is desirable that the above-mentioned support portion 32 has a support column 52 at least at a position opposite to the obstacle 36 and the support column 52 has an opposing portion 56 opposite to the obstacle 36, which is tapered.

According to the other aspect of the present invention, the fire-extinguishing equipment is provided with any one of the above-mentioned nozzles.

### EFFECT OF THE INVENTION

The fire-extinguishing nozzle and the fire-extinguishing equipment according to the present invention can convert the low-pressure fire-extinguishing liquid into mist.

### BRIEF DESCRIPTION OF THE DRAWINGS

FIG. 1 is a schematic view of a sprinkler fire-extinguishing piping of a fire-extinguishing equipment according to an embodiment of the present invention;

FIG. 2 is a perspective view of a fire-extinguishing spray nozzle according to the embodiment of the present invention;

FIG. 3 is a front view of the fire-extinguishing spray nozzle according to the embodiment of the present invention;

FIG. 4 is a view, when seen in a direction indicated by an arrow, of the fire-extinguishing spray nozzle according to the embodiment of the present invention;

FIG. 5 is a sectional view of the fire-extinguishing spray nozzle according to the embodiment of the present invention;

FIG. 6 is a concept view showing a principle according to which the fire-extinguishing liquid radially injected from ports of the fire-extinguishing spray nozzle according to the embodiment of the present invention is converted to mist;

FIG. 7 is a first graph, which shows a sprinkling angle of the fire-extinguishing spray nozzle according to the embodiment of the present invention and the amount to be sprinkled just therebelow

FIG. 8 is a second graph, which shows a sprinkling angle of the fire-extinguishing spray nozzle according to the embodiment of the present invention and the amount to be sprinkled just therebelow;

FIG. 9 is a front view of a fire-extinguishing spray nozzle according to a first modification of the present invention;

FIG. 10 is a front view of a fire-extinguishing spray nozzle according to a second modification of the present invention; and

FIG. 11 is a perspective view of a fire-extinguishing spray nozzle according to a third modification of the present invention.

### EXPLANATION OF NUMERALS

10 . . . fire-extinguishing spray nozzle
15 . . . main piping
16 . . . auxiliary piping
17 . . . water-dividing header
18 . . . strait joint
20 . . . water-dividing pipe
30 . . . main body
32 . . . support portion
36 . . . obstacle
40, 41 . . . radially injecting ports
50 . . . beam
52 . . . support column
56 . . . opposite portion
60,61 . . . opposing surface
62 . . . inclined surface
63 . . . groove
64 . . . joint portion
65 . . . rounding
70, 72, 76 . . . fire-extinguishing liquid
74 . . . mist
100 . . . center axis
102 . . . radial injection region
200 . . . inner diameter
202 . . . diameter
204, 208 . . . width
206, 210 . . . length

### MOST PREFERRED EMBODIMENT OF THE INVENTION

Hereafter, an embodiment of the present invention will be explained with reference to the drawings. In the explanation mentioned below, the identical parts are designated by identical numerals and their names and functions are also the same. In consequence, detailed explanation about them is not repeated.

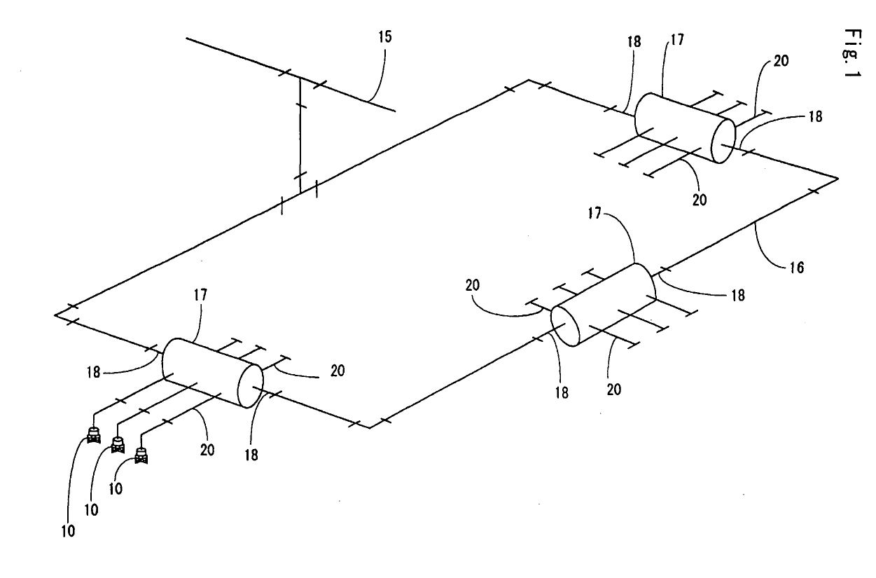

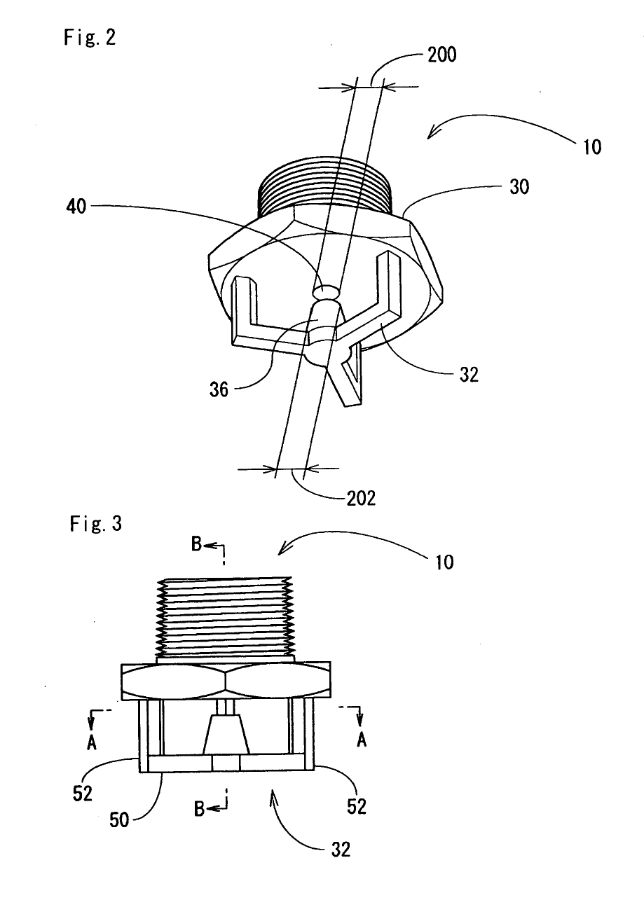

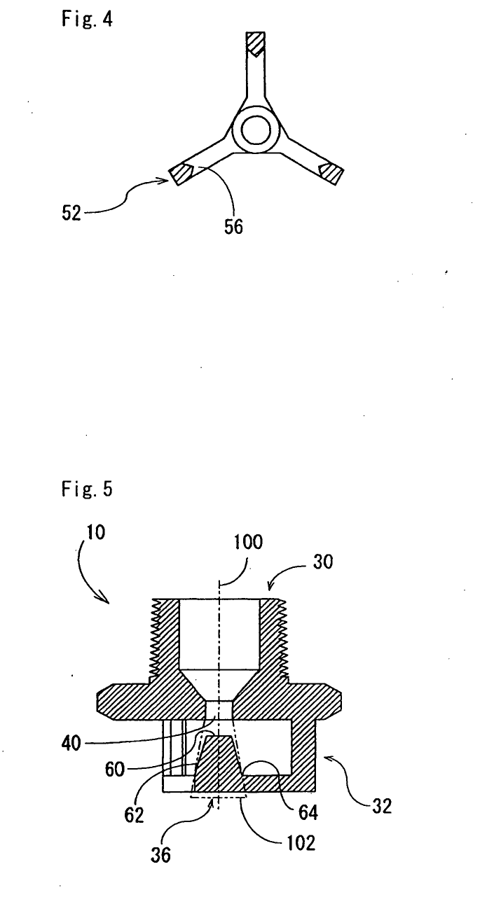

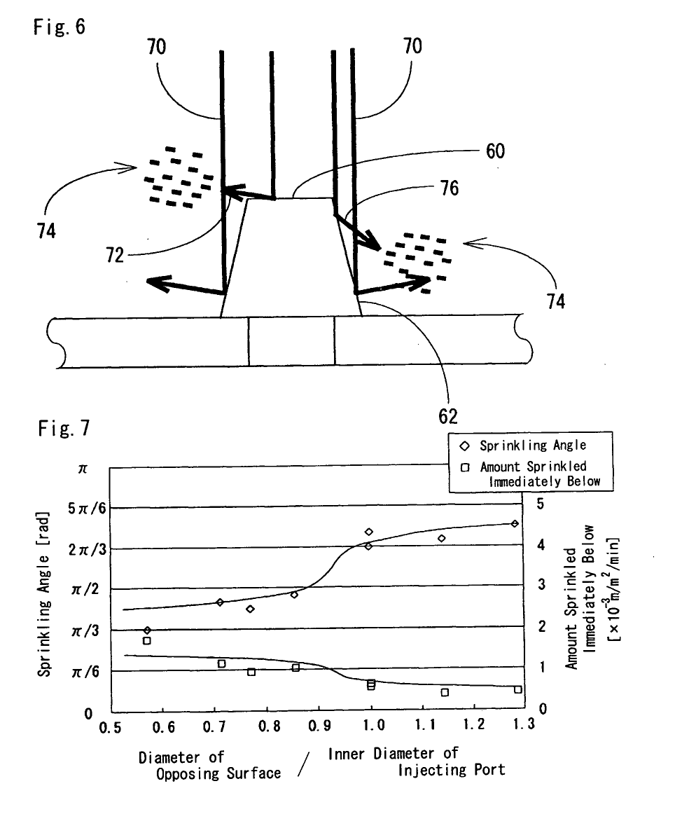

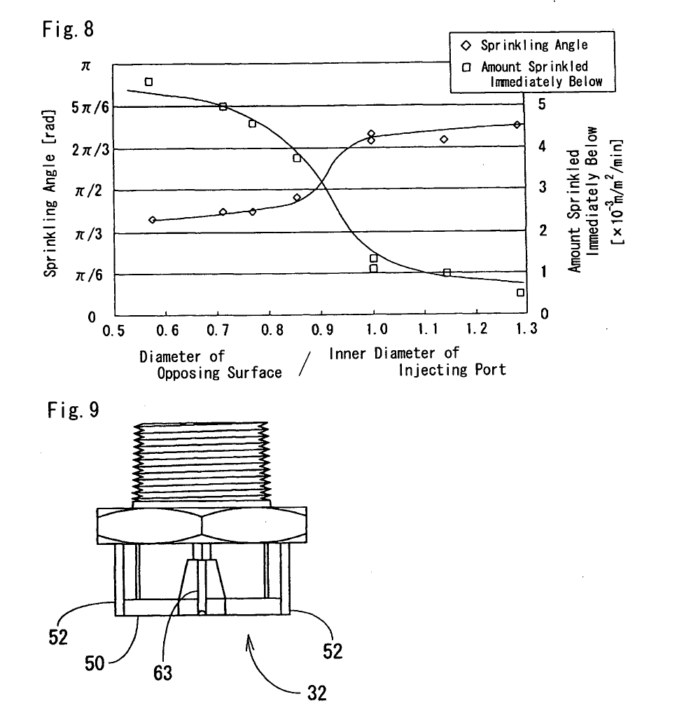

FIG. 1 is a schematic view showing a sprinkler fire-extinguishing piping of a fire-extinguishing equipment according to an embodiment of the present invention. FIGS. 2 and 3 show a perspective view and a front view, respectively of a fire-extinguishing spray nozzle 10 according to the present embodiment. FIG. 4 is a view, when seen in a direction indicated by arrows (A), of the fire-extinguishing spray nozzle 10 according to the embodiment of the present invention. FIG. 5 is a sectional view taken along a line B-B of the fire-extinguishing spray nozzle 10 according to the embodiment of the present invention. FIG. 6 is a concept view showing a principle according to which the fire-extinguishing liquid radially injected from a port 40 of the fire-extinguishing spray nozzle 10 according to the embodiment of the present invention is converted to mist. FIG. 7 is a first graph, which shows a sprinkling angle of the fire-extinguishing spray nozzle 10 according to the embodiment of the present invention and the amount to be sprinkled just therebelow. FIG. 8 is a second graph, which shows a sprinkling angle of the fire-extinguishing spray nozzle 10 according to the embodiment of the present invention and the amount to be sprinkled just therebelow. In the subsequent explanation, the amount to be sprinkled just below the fire-extinguishing spray nozzle 10 is referred to as ‘amount sprinkled immediately below’.

As shown in FIG. 1, the sprinkler fire-extinguishing piping of the fire-extinguishing equipment according to the embodiment of the present invention includes water-dividing headers 17. Each of the water-dividing headers 17 is integrally formed by molding from synthetic resin and serves to divide the water flowed in from a straight joint 18 into a plurality of pipes 20 and flow out the water residual after having divided it, into an auxiliary piping 16.

As shown in FIG. 1, the auxiliary piping 16 connected to the main piping 15 and arranged horizontally is formed in the shape of a loop. The loop-shape of the auxiliary piping 16 may be rectangular as shown or may be of a circular ring. Used for this auxiliary piping 16 is a synthetic resin tube having flexibility such as a polyethylene tube. The water-dividing header 17 is connected to the auxiliary piping 16 via the straight joint 18 and therefore is interposed in series with the loop-shaped auxiliary piping 16. The straight joint 18 is made of synthetic resin.

A water-dividing pipe 20 is formed from synthetic resin such as polyethylene resin. Further, it is desirable that all the water-dividing pipes 20 are preliminarily thermo-fused to the branching connection-portions in a factory prior to effecting the connection-work between the auxiliary piping 16 and the water-dividing header 17. In addition, employable for the water-dividing pipe 20 is that which is integrally formed with a hermetically sealing plug portion (not shown) at its leading end. If such a water-dividing pipe 20 is preliminarily connected, the water-dividing pipe 20 connected to the water-dividing header 17 has an opening at its leading end remaining as it is water-tightly sealed by the hermetically sealing plug portion. This brings forth an advantage that upon completion of installing the piping system extending from the main piping 15 to the water-dividing headers 17 as shown in FIG. 1, when a hydro-pressure test has been conducted, the hydro-pressure test can be carried out immediately without doing extra-work upon completion of the installation. And after the hydro-pressure test has been executed, if the water-dividing pipe 20 is cut at a desired portion in an axial direction and its hermetically sealing plug portion is removed, it becomes possible to connect the fire-extinguishing spray nozzle to the water-dividing pipe 20. Besides, while the plural water-dividing pipes 20 connected to the water-dividing pipes 17 are partly left as they posses hermetically sealing plug portions, the hermetically sealing plug portions are removed from the remaining ones so as for the flexible tube to be free for connection. This enables the water-dividing pipes 20 with the hermetically sealing plug portions still remaining to be used for increasing the number of installation of the fire-extinguishing spray nozzles 10 thereafter.

The synthetic resin tube with flexibility such as polyethylene tube is adopted for the flexible tube. The water-dividing pipe 20 can be connected to the flexible tube, for example, through the straight joint of synthetic resin.

It is possible to use a synthetic resin tube having a smooth inner surface (e.g. polyethylene tube) for the flexible tube according to the embodiment of the present invention. Then even if a number of flexible tubes are connected to a single water-dividing header 17, a full amount of discharged-water can be supplied to the fire-extinguishing spray nozzle 10 with a full pressure. Besides, since the flexible tube becomes light, it brings about an advantage that there is no need of taking so much care for the weight to be burdened by connecting the flexible tube.

As shown in FIG. 2, the fire-extinguishing spray nozzle 10 according to the embodiment of the present invention comprises a main body 30, a support portion 32 and an obstacle 36. The main body 30 has a radially injecting port 40, through which the fire-extinguishing liquid (water in this embodiment) supplied from a pump (not shown) is radially injected. The radially injected fire-extinguishing liquid collides with the obstacle 36 to become mist 74. The principle according to which the fire-extinguishing liquid is converted to the mist 74 is mentioned later.

With reference to FIGS. 3 and 4, an explanation is given for the construction of the support portion 32. The support portion 32 comprises a beam 50 and support columns 52. The beam 50 is a member to which the obstacle 36 is fixed. Each of the support columns 52 is a member which is secured to the main body 30 and supports the beam 50 in such a manner that it opposes to the beam 50 with the obstacle 36 interposed therebetween. The beam 50 comes to be a beam with its opposite ends supported by the support columns 52. Each of the support columns 52 has an opposing portion 56 opposite to the obstacle 36, which is sharply tapered toward the obstacle 36.

With reference to FIGS. 2 and 5, an explanation is made for the construction of the obstacle 36. The obstacle 36 has an opposing surface 60 and an inclined surface 62.

The opposing surface 60 in the embodiment is a plane perpendicular to an extension line of a center axis 100 of the radially injecting port 40 and opposite to the port 40. In this embodiment, the opposing surface 60 has a shape similar to that of the radially injecting port 40. Apparently from FIGS. 2 and 4, the radially injecting port 40 and the opposing surface 60 are circular in shape. Further, the opposing surface 60 has a center axis coincident with the center axis 100 of the radially injecting port 40. In this embodiment, the opposing surface 60 has a diameter 202 which is 90% of an inner diameter of the radially injecting port 40. A joint portion 64 of the beam 50 to the inclined surface 62 has an outer diameter larger than an inner diameter of the radially injecting port 40. Thus the opposing surface 60 is arranged within a radial-injection region 102 that means a region through which the fire-extinguishing liquid radially injected from the port 40 will pass. In FIG. 5, the radial-injection region 102 of this embodiment is indicated by two-dot chain line. With the extension line of the center axis 100 of the radially injecting port 40 taken as an axis of rotation, a space delimited by a truncated-cone having as a bus line, a straight line of which passes by the edge of the port 40 may be considered to be included within the radial-injection region 102.

In the mean time, as shown in FIGS. 2 to 5, in this embodiment, the inclined surface 62 is an outer peripheral surface of the obstacle 36, which is truncated-conical in shape. More specifically, the obstacle 36 is formed in the shape of a truncated-cone. In short, it has a shape of a portion remaining after the conical body has its top portion cut by a plane parallel to a bottom surface. Of course, the obstacle 36 may be truncated-conical in its real meaning.

With reference to FIG. 6, an explanation is made for the principle according to which the fire-extinguishing liquid radially injected by the port 40 is converted to the mist 74.

One part of the fire-extinguishing liquid radially injected from the port 40 collides with the opposing surface 60 and is reflected. This is the fire-extinguishing liquid 72 reflected from the opposing surface 60 in FIG. 6. The other part of the fire-extinguishing liquid passes around the opposing surface 60. This is the fire-extinguishing liquid 70 passing around the opposing surface 60 in FIG. 6. The fire-extinguishing liquid 72 reflected from the opposing surface 60 collides with the fire-extinguishing liquid 70 which passes around the opposing surface 60. Owing to this collision, the fire-extinguishing liquid 70 passing around the opposing surface 60 comes to be the mist 74 and is sprinkled therearound as well as the fire-extinguishing liquid 72 that has collided with the opposing surface 60.

The fire-extinguishing liquid radially injected from the radially injecting port 40 partly collides with the inclined surface 62 of the obstacle 36 and is reflected. And the fire-extinguishing liquid 76 reflected from the inclined surface 62 also collides with the fire-extinguishing liquid 70 which passes around the opposing surface 60. This collision enables the fire-extinguishing liquid 70 passing around the opposing surface 60 to become the mist 74 and be sprinkled therearound as well as the fire-extinguishing liquid 76 that has reflected from the inclined surface 62.

Further, as shown in FIG. 4, an opposing portion 56 opposite to the obstacle 36 of the support column 52 is sharply tapered toward the obstacle 36, so that the produced mist 74 flows along the side surface of the support column 52.

Additionally, the mist 74 is produced by resorting to such a principle and therefore the opposing surface 60 need not always have an angle perpendicular to the extension line of the center axis 100. Even if the angle is not perpendicular thereto, as far as it satisfies the following requirements, it is sufficient. The requirements are such that a phenomenon in which the fire-extinguishing liquid of a pressure required to produce the mist 74 is radially injected from the port 40 to collide with the opposing surface 60 and be reflected around the obstacle 36 occurs at a plurality of points on the opposing surface 60 to be mentioned later. And the plural points are mutually symmetric with respect to the extension line of the center axis 100.

In the manner as mentioned above, the fire-extinguishing spray nozzle 10 of this embodiment produces the mist 74 attributable to the collision occurring between the fire-extinguishing liquids radially injected from the port 40. The thus produced mist 74 is heated by flame to become water vapor, which has a volume far larger than that of the original mist 74. The water vapor drifts in the air to relatively reduce the oxygen concentration in the air with the result of causing a state of lack of oxygen in which a flammable substance and among others, oil is hardly burnt.

For fire-extinguishing purpose, the mist 74 sprinkled from the fire-extinguishing spray nozzle 10 desirably spreads as widely and uniformly as possible. However, it has been conventionally not so easy to sufficiently sprinkle the mist just below the fire-extinguishing spray nozzle 10. The fire-extinguishing spray nozzle 10 according to the present embodiment can sufficiently sprinkle the mist 74 just therebelow. Based on FIGS. 7 and 8, this point is explained.

FIGS. 7 and 8 each shows that the ratio of the diameter of the opposing surface 60 to the inner diameter of the radially injecting port 40 exerts an influence on the sprinkling angle as well as on the amount to be sprinkled just below the fire-extinguishing spray nozzle 10. FIG. 7 shows a case where the fire-extinguishing liquid supplied to the fire-extinguishing spray nozzle 10 has a pressure of 0.4 MPa and FIG. 8 shows a case where the pressure is 1.0 MPa. These Figures have been obtained by measuring the sprinkling angle and the amount to be sprinkled just below as regards each of the fire-extinguishing spray nozzle 10 of various sorts having the same construction as that of the present embodiment with the inner diameter of the radially injecting port 40 and the diameter of the opposing surface 60 differentiated from those of the others.

Judging from the results shown in FIGS. 7 and 8, it is conceived that in the case where the ratio of the diameter of the opposing surface 60 to the inner diameter of the radially injecting port 40 is not more than ‘0.9 ’, the amount to be sprinkled just below the fire-extinguishing spray nozzle 10 is augmented by increasing the pressure of the fire-extinguishing liquid fed to the fire-extinguishing spray nozzle 10. But on the other hand, with the ratio exceeding ‘1’, even if the pressure of the fire-extinguishing liquid supplied to the fire-extinguishing spray nozzle 10 is increased, it does not augment so much the amount to be sprinkled just below the fire-extinguishing spray nozzle 10. In consequence, it is considered that the ratio of not more than ‘0.9’ enables the fire-extinguishing liquid to be fully sprinkled just below the fire-extinguishing spray nozzle 10.

In addition, FIGS. 7 and 8 are conceived to show that the pressure of the fire-extinguishing liquid fed to the fire-extinguishing spray nozzle 10 does not exert much influence on the sprinkling angle because in FIGS. 7 and 8, even if the pressure is different, there is not seen any difference in the sprinkling angle. On the other hand, it would be considered to exert an influence on the sprinkling angle whether or not the ratio of the diameter of the opposing surface 60 to the inner diameter of the radially injecting port 40 exceeds the threshold within a range of 0.9 to 1.0. It is seen from FIGS. 7 and 8 that if the ratio of the diameter of the opposing surface 60 to the inner diameter of the radially injecting port 40 is not more than 0.9, the sprinkling angle is it π/3 radian to it π/2 radian and if this ratio exceeds 1.0, the sprinkling angle is 2π/3 radian to 5π/6 radian.

Accordingly, as mentioned above, in the fire-extinguishing spray nozzle 10 according to the present embodiment, the diameter of the opposing surface 60 is 90% of the inner diameter of the radially injecting port 40 and therefore if the fire-extinguishing liquid of 1.0 MPa is fed, it is possible to fully supply the fire-extinguishing liquid to just below the fire-extinguishing spray nozzle 10.

The embodiment disclosed this time is for example only on all points. The scope of the present invention is not limited to the above mentioned embodiment but as a matter of course, various sorts of design changes may be made as far as it does not deviate from the subject matter of the present invention.

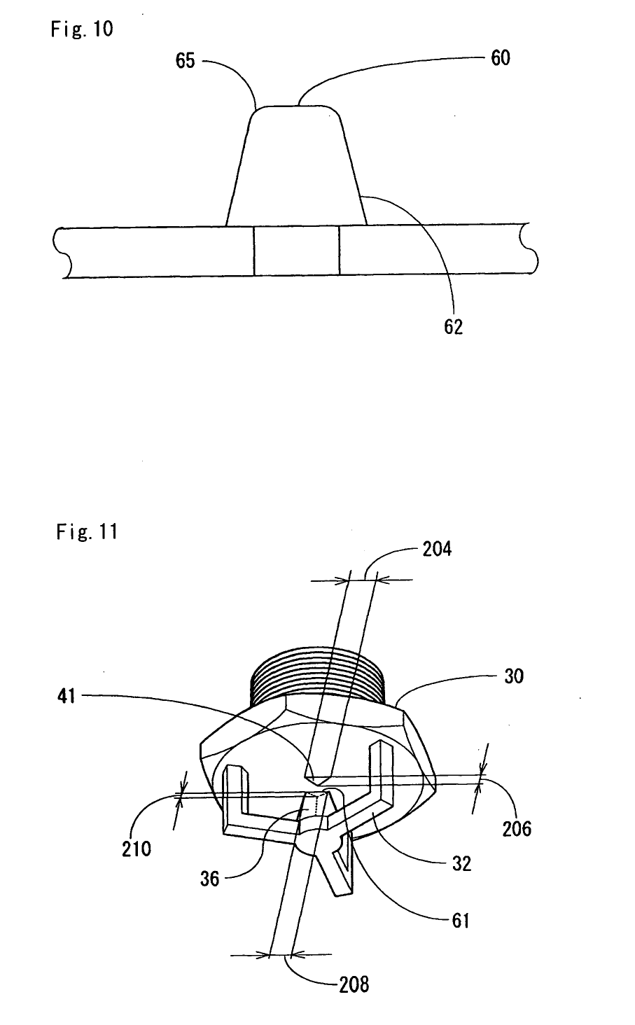

For example, the inclined surface 62 may be provided with a groove 63. FIG. 9 is a front view of a fire-extinguishing spray nozzle in which the inclined surface 62 is provided with the groove 63. A rounding 65 may be provided on a boundary between the opposing surface 60 and the inclined surface 62. FIG. 10 is a front view of a fire-extinguishing spray nozzle when it is provided with such a rounding.

Further, the ratio of the diameter of the opposing surface 60 to the inner diameter of the radially injecting port 40 is not limited to 0.9.

Moreover, the main body 30 may have a radially injecting port of a shape different from a circle instead of the circular port 40. In this case, the obstacle 36 may have an opposing surface of the other shape instead of the circular opposing surface 60. FIG. 11 is a perspective view showing a form of a fire-extinguishing spray nozzle in the case where the main body 30 has a triangular radially injecting port 41 and the obstacle 36 has a triangular opposing surface 61. In this case, the opposing surface 61 may have a center axis which need not always be coincident with that of the radially injecting port 41. Of course, they may be coincident with each other.

Besides, the opposing surface may have a shape dissimilar to that of the radially injecting port.

1. A fire-extinguishing spray nozzle comprising a main body with a port for radially injecting fire-extinguishing liquid and an obstacle with which the fire-extinguishing liquid radially injected from the port collides, wherein
the obstacle includes an opposing surface opposite to the radially injecting port, and
the opposing surface is arranged within a radial-injection region of the fire-extinguishing liquid radially injected from the radially injecting port.

2. A fire-extinguishing spray nozzle according to claim 1, wherein
the opposing surface is similar to the radially injecting port in shape.

3. A fire-extinguishing spray nozzle according to claim 2, wherein
the radially injecting port is circular in shape and the opposing surface has a circular shape.

4. A fire-extinguishing spray nozzle according to claim 1, wherein
the opposing surface has a center axis coincident with that of the radially injecting port.

5. A fire-extinguishing spray nozzle according to claim 1, wherein
the obstacle is fixed through a support portion to the main body.

6. A fire-extinguishing spray nozzle according to claim 5, wherein
the support portion has a support column at least at a position opposite to the obstacle and the support column has an opposing portion opposite to the obstacle, which is tapered.

7. A fire-extinguishing equipment provided with a fire-extinguishing spray nozzle as defined in any one of claims 1 to 6.
